(19) United States
(12) Patent Application Publication
(10) Pub. No.: US 2022/0225812 A1
(43) Pub. Date: Jul. 21, 2022

(54) SYSTEM AND METHOD FOR CONTROLLING ELECTRIC CURTAIN

(71) Applicant: NINGBO SUNFREE MOTOR TECHNOLOGY COMPANY LIMITED, Ningbo City (CN)

(72) Inventors: Chun JIANG, Ningbo City (CN); Baoguo TAN, Ningbo City (CN)

(21) Appl. No.: 17/492,701

(22) Filed: Oct. 4, 2021

(30) Foreign Application Priority Data
Jan. 15, 2021 (CN) 202110056779.9

(51) Int. Cl. A47H 23/00; H04W 4/80; H04L 29/08

(52) U.S. Cl. CPC A47H 23/00; H04L 67/125; H04W 4/80

(57) ABSTRACT

The present invention has provided a system and method for controlling an electric curtain, which comprises a remote controller end and a curtain end; the remote controller end comprising a first processor, a radio frequency transmitting module, and a button module; the button module and the radio frequency transmitting module are both in electrical connection with the first processor; the curtain end comprises a second processor, a curtain motor, and a radio frequency receiving module; the curtain motor and the radio frequency receiving module are both in electrical connection with the second processor, and the remote controller end further comprises a first NFC communication module in electrical connection with the first processor, and a second NFC communication module with a curtain motor ID; the first NFC communication module and the second NFC communication module are in communication connection, proving the efficiency of the matching of the electric curtain control system.

### CROSS REFERENCE TO THE RELATED APPLICATIONS

This application is based upon and claims priority to Chinese Patent Application No. 202110056779.9, filed on Jan. 15, 2021, the entire contents of which are incorporated herein by reference.

### TECHNICAL FIELD

The present invention relates to the field of electric curtain technologies, and in particular to a system and method for controlling an electric curtain.

### BACKGROUND

Wireless control of electric curtains is achieved through motor drive. According to installation type, the electric curtains may be divided into an internal type electric curtain and an external type electric curtain. According to different operation mechanisms and decoration effects, the electric curtains may be divided into electric opening-closing curtains, electric lifting curtains, electric ceiling curtains, electric sunshade boards, electric awnings, and the like, such as a blind curtain, a roller curtain, a Roman curtain, a soft gauze curtain, an accordion curtain and a honeycomb curtain. The electric curtains have functions such as privacy protection, light utilization, wall decoration, sound absorption and noise reduction.

The electric curtain is generally controlled by controlling a curtain motor with a remote controller. However, the remote controller needs to be firstly matched with the curtain motor before performing control. In the prior art, since the remote controller can only communicate with the curtain motor by radio frequency, many operations are required for matching, such that a user has to perform matching operations step by step according to a manual, leading to complex matching.

### SUMMARY

The technical problem to be solved by the present invention is to provide a system and method for controlling an electric curtain, in which matching is performed easily.

The technical solution adopted by the present invention is described below. A system for controlling an electric curtain comprises a remote controller end and a curtain end. The remote controller end comprises a first processor, a radio frequency transmitting module, and a button module; the button module and the radio frequency transmitting module are both in electrical connection with the first processor. The curtain end comprises a second processor, a curtain motor, and a radio frequency receiving module; the curtain motor and the radio frequency receiving module are both in electrical connection with the second processor. The remote controller end further comprises a first NFC communication module in electrical connection with the first processor, and a second NFC communication module with a curtain motor ID in communication connection with the first NFC communication module is further provided.

Preferably, the second NFC communication module is a passive NFC electronic tag.

Preferably, a sticking layer is disposed on the NFC electronic tag.

Preferably, a shielding layer is further disposed between the sticking layer and the NFC electronic tag.

Preferably, the second NFC communication module is an active NFC communication module in electrical connection with the second processor.

A method of controlling an electric curtain comprises the following steps.

In step S1, after the remote controller end is moved to approach the second NFC communication module, the first NFC communication module in the remote controller end reads motor ID information stored in the second NFC communication module, and then transmits the read motor ID to the first processor.

In step S2, the first processor sends the read motor ID and its self-contained radio frequency ID to the curtain end through the radio frequency transmitting module.

In step S3, the second processor of the curtain end receives the motor ID and the radio frequency ID through the radio frequency receiving module, and then compares the received motor ID with its stored motor ID; if the two motor IDs are different, it indicates that the matching is unsuccessful and a re-matching state is entered; if the two motor IDs are same, it indicates that matching is successful and the radio frequency ID is recorded.

Compared with the prior art, the present invention adopting the above structure and method has the following advantages. Since the remote controller end is provided with a first NFC communication module and a second NFC communication module with a curtain motor ID is further provided, the first NFC communication module may obtain the curtain motor ID simply by approaching the second NFC communication module; then, the radio frequency transmitting module of the remote controller end may send the motor ID and its stored ID to the curtain end to realize matching of two motor IDs. In this way, the user only needs to move the remote controller to approach the second NFC communication module in a case of matching. Therefore, the operation is very easy.

The second NFC communication module is made into the passive NFC electronic tag which can be easily installed without power supply. The passive NFC electronic tag may be installed at a position facilitating operation according to requirements, or may not be installed for taking out directly for matching at any time.

The sticking layer is disposed on the NFC electronic tag, so that the NFC electronic tag may be conveniently stuck at any desired position, leading to easy fixed installation.

The shielding layer is disposed between the sticking layer and the NFC electronic tag, so that the NFC electronic tag may be stuck on a metal material and signals are not affected by the metal material, leading to more convenient use.

The second NFC communication module may be an active NFC communication module in electrical connection with the second processor. In this way, when the remote controller end approaches the curtain end, matching can be realized through only one communication transmission rather than several communication transmissions.

### BRIEF DESCRIPTIONS OF THE DRAWINGS

FIG. 1 is a block diagram of module connection of a system for controlling an electric curtain according to a first embodiment of the present invention.

FIG. 2 is a block diagram of module connection of a system for controlling an electric curtain according to a second embodiment of the present invention.

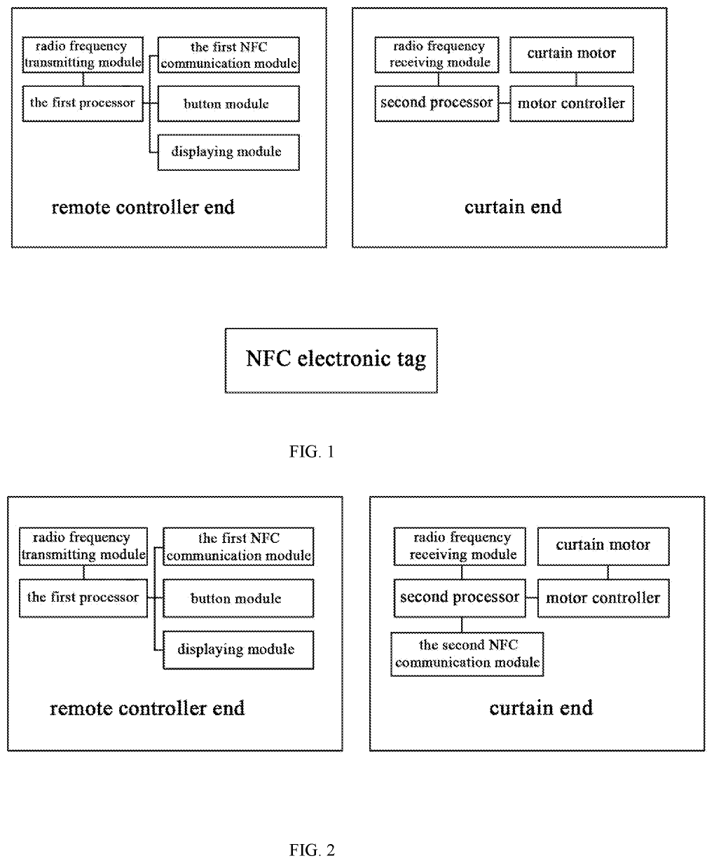

### EMBODIMENTS

The present invention will be further described below through specific embodiments, but the present invention is not limited to the following specific embodiments.

In a first embodiment, provided is a system for controlling an electric curtain, comprising a remote controller end, a curtain end and a separate NFC electronic tag with a curtain motor ID.

The remote controller end mainly comprises a housing, a first processor (MCU), a radio frequency transmitting module, a first NFC communication module, a button module and a displaying module. The button module, the radio frequency transmitting module, the first NFC communication module and the displaying module are all in electrical connection with the first processor. The first processor, the first NFC communication module and the radio frequency transmitting module are disposed inside the housing, and the button module and the displaying module are exposed outside the housing. The button module is in charge of user input, the displaying module is in charge of outputting some information to be viewed by a user, the radio frequency transmitting module is in charge of sending information to the curtain end, and the first NFC communication module which is in charge of matching of the remote controller end and the curtain end is active, which is available in many types on market and thus will not be detailed herein.

The curtain end mainly comprises a second processor (MCU), a radio frequency receiving module, a curtain motor and a motor controller. The radio frequency receiving module and the motor controller are in electrical connection with the second processor, and the curtain motor is in electrical connection with the motor controller. The curtain motor is mainly used to drive the curtain to move so as to realize functions of opening and closing the curtain, the motor controller is mainly used to control the motor, and the radio frequency receiving module is mainly configured to receive information from the radio frequency transmitting module.

The NFC electronic tag is mainly used to store the curtain motor ID. Further, only one NFC electronic tag may be disposed, so that a user may directly perform matching operation after opening. The NFC electronic tag may also be provided only with the sticking layer, and thus the NFC electronic tag may be stuck at an ordinary position facilitating operation, and the user may perform matching operation by moving the remote controller to approach the stuck electronic tag. The shielding layer may be further disposed behind the sticking layer of the NFC electronic tag, and thus the NFC electronic tag may be stuck on a metal material, for example, on a metal tube, without being interfered by the metal. The NFC electronic tag may also have a hanging buckle, and can be hung at any desired position.

The whole system works based on the following principle: the remote controller end approaches the NFC electronic tag to enable the first NFC communication module to approach the NFC electronic tag, so that the NFC electronic tag will send its stored curtain motor ID to the first NFC communication module; then, the first NFC communication module sends the received curtain motor ID to the first processor; next, the first processor sends its stored radio frequency ID and the received curtain motor ID to the curtain end through the radio frequency transmitting module, and the radio frequency receiving module of the curtain end receives the curtain motor ID and the radio frequency ID and compares whether a curtain motor ID stored in the curtain end is identical to the received curtain motor ID; if the two motor IDs are same, the radio frequency ID is recorded and two motor IDs are matched, and then, the remote controller end may directly control the motor of the curtain end to operate; if the curtain motor ID stored in the curtain end is not identical to the received curtain motor ID, it indicates that matching is unsuccessful, and the remote controller end cannot control the curtain motor of the curtain end to operate.

In a second embodiment, provided is a system for controlling an electric curtain, comprising a remote controller end and a curtain end.

The remote controller end comprises a housing, a first processor (MCU), a radio frequency transmitting module, a first NFC communication module, a button module and a displaying module. The button module, the radio frequency transmitting module, the NFC communication module and the displaying module are all in electrical connection with the first processor. The first processor, the first NFC communication module and the radio frequency transmitting module are disposed inside the housing, and the button module and the displaying module are exposed outside the housing. The button module is in charge of user input, the displaying module is in charge of outputting some information to be viewed by a user, the radio frequency transmitting module is in charge of sending information to the curtain end, and the first NFC communication module which is in charge of matching of the remote controller end and the curtain end is active, which is available in many types on market and will not be detailed herein.

The curtain end mainly comprises a second processor (MCU), a radio frequency receiving module, a second NFC communication module, a curtain motor and a motor controller. The radio frequency receiving module, the second NFC communication module and the motor controller are in electrical connection with the second processor, and the curtain motor is in electrical connection with the motor controller. The curtain motor is mainly used to drive the curtain to move so as to realize functions of opening and closing the curtain, the motor controller is mainly used to control the motor, and the radio frequency receiving module is mainly configured to receive information from the radio frequency transmitting module. The second NFC communication module which is in charge of matching of the curtain end and the remote controller end is active, which is available in many types on market and thus will not described in detail herein.

The system works based on the following principle: the remote controller end is moved to approach the curtain end to enable the first NFC communication module in the remote controller end to approach the second NFC communication module in the curtain end; then, the first NFC communication module may obtain a curtain motor ID and then send the curtain ID and the radio frequency ID to the curtain end to facilitate matching the remote controller end with the curtain end.

Finally, it is to be pointed out that the above embodiments are merely used to describe the technical solutions of the present invention rather than limit the present invention. Although the detailed descriptions are made to the present invention by referring to the preceding embodiments, those skilled in the art should understand that the technical solutions recorded in the above embodiments may still be modified or part of technical features thereof may be equivalently substituted. Such modifications or substitutions will not cause the essences of the corresponding technical solutions to depart from the spirits and scopes of the technical solutions of various embodiments of the present invention.

1. A system for controlling an electric curtain, comprises a remote controller end and a curtain end; the remote controller end comprising a first processor, a radio frequency transmitting module, and a button module; the button module and the radio frequency transmitting module are both in electrical connection with the first processor; the curtain end comprises a second processor, a curtain motor, and a radio frequency receiving module; the curtain motor and the radio frequency receiving module are both in electrical connection with the second processor, wherein the remote controller end further comprises a first NFC communication module in electrical connection with the first processor, and a second NFC communication module with a curtain motor ID; the first NFC communication module and the second NFC communication module are in communication connection.

2. The system for controlling an electric curtain of claim 1, wherein the second NFC communication module is a passive NFC electronic tag.

3. The system for controlling an electric curtain of claim 2, wherein a sticking layer is disposed on the NFC electronic tag.

4. The system for controlling an electric curtain of claim 3, wherein a shielding layer is further disposed between the sticking layer and the NFC electronic tag.

5. The system for controlling an electric curtain of claim 1, wherein the second NFC communication module is an active NFC communication module in electrical connection with the second processor.

6. A method of controlling an electric curtain, wherein it comprises the following steps:
step S1, after the remote controller end is moved to approach the second NFC communication module, the first NFC communication module in the remote controller end reads motor ID information stored in the second NFC communication module, and then transmits the read motor ID to the first processor;
step S2, the first processor sends the read motor ID and its self-contained radio frequency ID to the curtain end through the radio frequency transmitting module;
step S3, the second processor of the curtain end receives the motor ID and the radio frequency ID through the radio frequency receiving module, and then compares the received motor ID with its stored motor ID; if the two motor IDs are different, it indicates that the matching is unsuccessful and a re-matching state is entered; if the two motor IDs are same, it indicates that matching is successful and the radio frequency ID is recorded.
